(19) United States
(12) Patent Application Publication
(10) Pub. No.: US 2016/0284442 A1
(43) Pub. Date: Sep. 29, 2016

(54) COAXIAL CABLE

(71) Applicant: FUJITSU LIMITED, Kawasaki-shi (JP)

(72) Inventor: Teng-Kai CHEN, Santa Clara, CA (US)

(21) Appl. No.: 14/667,416

(22) Filed: Mar. 24, 2015

(51) Int. Cl. H01B 11/18; H01B 13/016; H01B 13/00; H01B 7/02

(52) U.S. Cl. CPC H01B 11/1856; H01B 7/0216; H01B 13/016; H01B 13/0036; H01B 11/1895

(57) ABSTRACT

A coaxial cable as disclosed may include an inner conductor and an outer conductor surrounding the inner conductor in a coaxial relationship. The coaxial cable may also include a first insulative material located between the inner conductor and the outer conductor at a non-bent portion of the coaxial cable and a bent portion of the coaxial cable. The first insulative material may have a first dielectric constant. The coaxial cable may also include a second insulative material located between the inner conductor and the outer conductor at the bent portion of the coaxial cable. The second insulative material may have a second dielectric constant that may be less than the first dielectric constant.

### FIELD

The present disclosure relates to coaxial cables.

### BACKGROUND

Data communications have become an increasingly prevalent form of electromagnetic information exchange and coaxial cables are one of many common conduits for transmission of data communications. Coaxial cables are typically designed so that an electromagnetic field carrying communication signals exists only in the space between inner and outer coaxial conductors of the cables. The location of the electromagnetic field carrying communication signals may allow coaxial cable runs to be installed next to metal objects without the power losses that occur in other transmission lines, and may provide protection of the communication signals from external electromagnetic interference. Connectors for coaxial cables may be typically connected onto complementary interface ports to electrically integrate coaxial cables to various electronic devices and cable communication equipment. When running coaxial cables between equipment, such as between servers, the coaxial cables may bend, twist, or form other angles that may affect the electromagnetic field carrying the communications signals.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a coaxial cable may include an inner conductor and an outer conductor surrounding the inner conductor in a coaxial relationship. The coaxial cable may also include a first insulative material located between the inner conductor and the outer conductor at a non-bent portion of the coaxial cable and a bent portion of the coaxial cable. The first insulative material may have a first dielectric constant. The coaxial cable may also include a second insulative material located between the inner conductor and the outer conductor at the bent portion of the coaxial cable. The second insulative material may have a second dielectric constant that may be less than the first dielectric constant.

The object and advantages of the embodiments will be realized and achieved at least by the elements, features, and combinations particularly pointed out in the claims.

It is to be understood that both the foregoing general description and the following detailed description are exemplary and explanatory and are not restrictive of the present disclosure, as claimed.

### BRIEF DESCRIPTION OF THE DRAWINGS

Example embodiments will be described and explained with additional specificity and detail through the use of the accompanying drawings in which:

FIG. 1a illustrates a coaxial cable with a bend;

FIG. 1b illustrates a horizontal cross-section of the coaxial cable of FIG. 1a;

FIG. 1c illustrates a vertical cross-section of a non-bent portion of the coaxial cable of FIG. 1a;

FIG. 1d illustrates a vertical cross-section of a bent portion of the coaxial cable of FIG. 1a;

FIG. 2 illustrates a horizontal cross-section of another coaxial cable with a bend;

FIG. 3 illustrates a horizontal cross-section of another coaxial cable with a bend;

FIG. 4 is a flow chart of an example method to design a coaxial cable with a bend;

FIG. 5 is a flow chart of another example method to design a coaxial cable with a bend; and

FIG. 6 illustrates a system configured to design a coaxial cable with a bend.

### DESCRIPTION OF EMBODIMENTS

Some embodiments described herein relate to a coaxial cable and to the characteristics of a coaxial cable in a bent portion of the coaxial cable. One of the characteristics of the coaxial cable may include the bent portion of the coaxial cable including first and second insulative materials between an inner conductor and an outer conductor of the coaxial cable. A dielectric constant of the first insulative material may be higher than a dielectric constant of the second insulative material. In some embodiments, the non-bent portion of the coaxial cable may also include the first insulative material between the inner and outer conductors.

In some embodiments, the characteristics of the coaxial cable at the bent portion of the coaxial cable may reduce one or more of impedance discontinuity, attenuation, resonance, reflection, and unwanted electromagnetic modes that may result because of the bent portion of the coaxial cable.

Embodiments of the present disclosure will be explained with reference to the accompanying drawings.

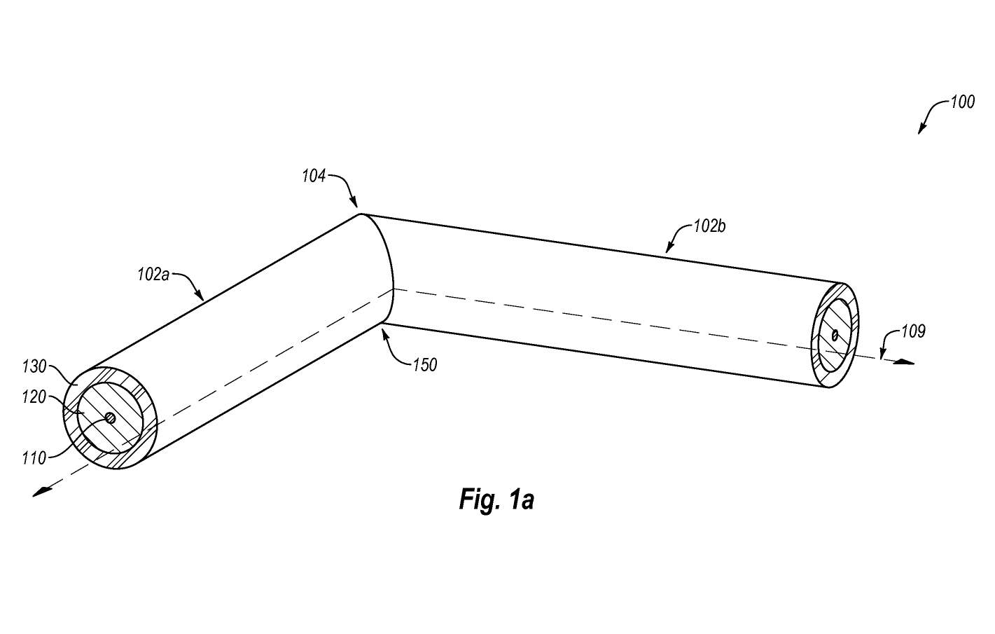

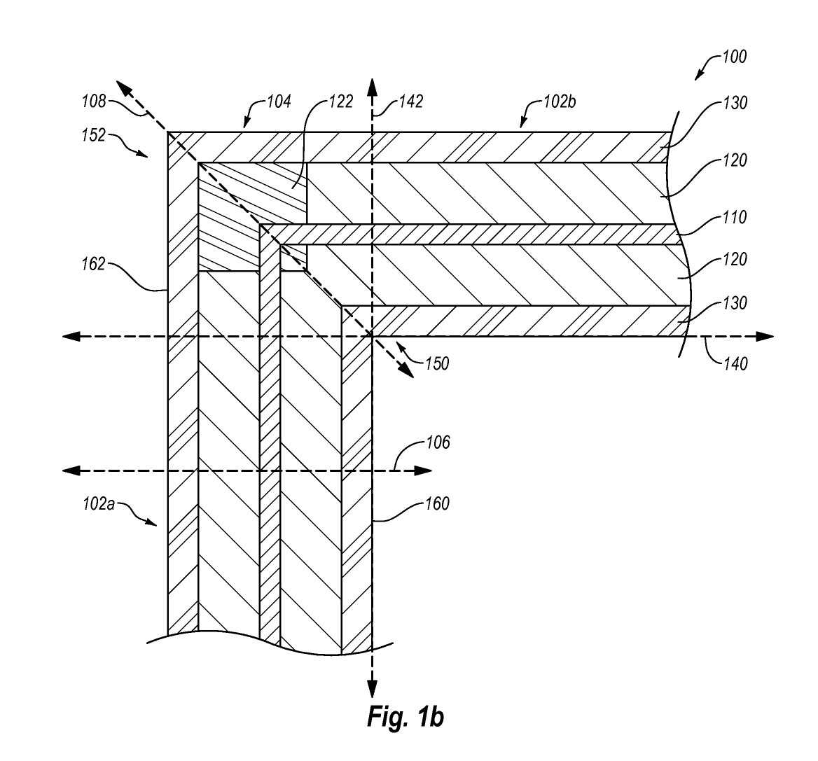

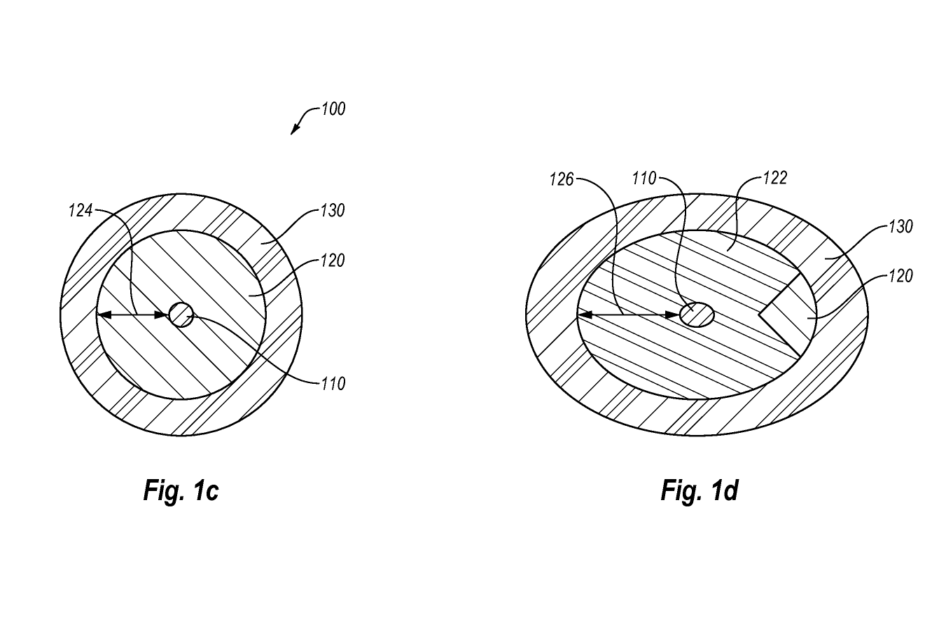

FIG. 1a illustrates a coaxial cable 100 with a bend, arranged in accordance with at least one embodiment of the present disclosure. The coaxial cable 100 may include an inner conductor 110, a first insulative material 120, and an outer conductor 130. The first insulative material 120 may surround and contact the inner conductor 110 in a coaxial relationship. The outer conductor 130 may surround and contact the first insulative material 120 in a coaxial relationship. As a result, the outer conductor 130 may also surround the inner conductor 110 in a coaxial relationship.

The first insulative material 120 may include a dielectric material. For example, the first insulative material 120 may include one or more of polyimide, carbon disulfide, polystyrene, polytetrafluoroethylene, polyethylene, among other types of dielectric or insulative materials. The inner conductor 110 and the outer conductor 130 may include one or more conductive materials. For example, the inner conductor 110 and the outer conductor 130 may include gold, copper, silver, carbon, or some other conductive material.

The coaxial cable 100 may also include first and second non-bent portions 102a and 102b (referred to herein as the non-bent portions 102) and a bent portion 104. The bent portion 104 of the coaxial cable 100 may result when an angle other than 0 or 180 degrees is formed between the first and second non-bent portions 102a and 102b of the coaxial cable 100.

As illustrated in FIG. 1 a, the coaxial cable 100 may generally have a circular cross-sectional shape in both the bent portion 104 and the non-bent portions 102. The coaxial cable 100 may have other cross-sectional shapes as well. For example, the coaxial cable 100, the inner conductor 110, the first insulative material 120, and the outer conductor 130 may have square, quadrilateral, elliptical, polygonal, or some other cross-sectional shape.

Alternately or additionally, the bent portion 104 of the coaxial cable 100 may have a first cross-sectional shape and the non-bent portions 102 of the coaxial cable 100 may have a second cross-sectional shape due to the bend in the coaxial cable 100. For example, the bent portion 104 may have an elliptical cross-sectional shape and the non-bent portions 102 may have a circular cross-sectional shape. In some embodiments, the first non-bent portion 102a may have a different cross-sectional shape than the second non-bent portion 102b.

FIG. 1b illustrates a horizontal cross-section of the coaxial cable of FIG. 1a along the line 109. FIG. 1b illustrates an inner corner 150 and outer corner 152 of the bent portion 104. In these and other embodiments, the inner corner 150 of the bent portion 104 may be defined as the side of the bent portion 104 where an angle between the first and second non-bent portions 102a and 102b is less than 180 degrees. In these and other embodiments, a first outer surface 160 of the outer conductor 130 may form the inner corner 150. The outer corner 152 of the bent portion 104 may be defined as the side of the bent portion 104 where an angle between the first and second non-bent portions 102a and 102b is more than 180 degrees. In these and other embodiments, a second outer surface 162 of the outer conductor 130 may form the outer corner 152.

As illustrated, the inner corner 150 of the bent portion 104 may be defined by a 90 degree angle between the first and second non-bent portions 102a and 102b. Thus, the bent portion 104 of the coaxial cable 100 may form a corner with a 90 degree angle. In these and other embodiments, the bent portion 104 of the coaxial cable 100 may be distinguished from the non-bent portions 102 by first and second planes 140 and 142. The first and second planes 140 and 142 may be planes in which the first outer surface 160 of the outer conductor 130 resides.

In some embodiments, the non-bent portions 102 of the coaxial cable 100 may have a generally consistent cross-sectional shape and size. In these and other embodiments, the bent portion 104 of the coaxial cable 100 may be defined as the portion of the coaxial cable 100 that has a cross-sectional shape and/or size different than a cross-sectional shape and/or size of the non-bent portions 102 of the coaxial cable due to the bend in the coaxial cable 100. In contrast, other coaxial cables may have bends, such as sweeping bends that traverse a gradual arc, where the cross-sectional shape and size of a bent portion may be similar or the same as the cross sectional shape of non-bent portions. Because the bent portion 104 has a cross sectional shape different than the non-bent portions 102, in this and other embodiments, the bent portion 104 may be referred to as a non-sweeping bend. In some embodiments, the bent portion 104 may have a cross sectional shape and/or size different than the non-bent portions 102 of the coaxial cable 100 due to the bent portion 104 being a non-sweeping bend.

As illustrated in FIG. 1b, the bent portion 104 may include the first insulative material 120 and a second insulative material 122 between the inner conductor 110 and the outer conductor 130. The second insulative material 122 may include one or more of polyimide, carbon disulfide, polystyrene, polytetrafluoroethylene, polyethylene, or gases, among other types of dielectric or insulative materials.

In some embodiments, the second insulative material 122 may include a dielectric material that is different from the dielectric material of the first insulative material 120. In these and other embodiments, the first insulative material 120 may have a first dielectric constant and the second insulative material 122 may have a second dielectric constant. In some embodiments, the second dielectric constant may be lower than the first dielectric constant. For example, the first insulative material 120 may include a polyimide with a dielectric constant of 3.4 and the second insulative material 122 may include a polystyrene with a dielectric constant of 2.6.

In some embodiments, including the first and second insulative materials 120 and 122 with different dielectric constants in the bent portion 104 may reduce an impedance difference in the inner conductor 110 between the bent portion 104 and the non-bent portions 102.

For example, the inner conductor 110 in the non-bent portions 102 may have a first impedance. In the bent portion 104, without the second insulative material 122 with a reduced dielectric constant, the inner conductor 110 may have a second impedance that is lower than the first impedance due to the non-sweeping bend of the coaxial cable 100.

In some embodiments, the change in impedance may be contributed to a change in the cross-section of the inner conductor 110 at bent portion 104 because the bent portion 104 is a non-sweeping bend. To reduce the difference between the first and second impedances, the second insulative material 122 may be added to the bent portion 104. Reducing the difference between the first and second impedances may reduce attenuation, resonance, reflection, and/or unwanted electromagnetic modes in signals propagating along the inner conductor 110 through the bent portion 104. Reducing attenuation, resonance, reflection, and/or unwanted electromagnetic modes in signals propagating along the inner conductor 110 through the bent portion 104 may improve transmission of a signal through the coaxial cable 100 and may enhance high frequency performance of a signal transmitted through the coaxial cable 100.

In some embodiments, the second insulative material 122 may be added to the bent portion 104 while maintaining or enlarging a distance between the inner and outer conductors 110 and 130 in the bent portion 104 as compared to a distance between the inner and outer conductors 110 and 130 in the non-bent portions 102. With the distance between the inner and outer conductors 110 and 130 in the bent portion 104 being greater than a distance between the inner and outer conductors 110 and 130 in the non-bent portions 102, the thickness of either the first insulative material 120, the second insulative material 122, or a combined thickness of the first and second insulative materials 120 and 122 may be substantially the same or greater than the thickness of the first insulative material 120 in the non-bent portions 102.

The distance between the inner and outer conductors 110 and 130 in the non-bent portions 102 is illustrated in FIG. 1c. In particular, FIG. 1c illustrates a vertical cross-section of the first non-bent portion 102a of the coaxial cable 100 along the line 106. As illustrated in FIG. 1c, the distance between the inner and outer conductors 110 and 130 in the first non-bent portion 102a may be a first distance 124. The thickness of the first insulative material 120 in the first non-bent portion 102a may be equal to the first distance 124.

A distance between the inner and outer conductors 110 and 130 in the bent portion 104 is illustrated in FIG. 1d. In particular, FIG. 1d illustrates a vertical cross-section of the bent portion 104 of the coaxial cable 100 along the line 108. As illustrated in FIG. 1d, the distance between the inner and outer conductors 110 and 130 in a portion of the bent portion 104 may be a second distance 126. The thickness of the first insulative material 120, the second insulative material 122, or a combination of the first and second insulative materials 120 and 122 in the portion of the bent portion 104 may be equal to the second distance 126. In some embodiments, the second distance 126 may be substantially the same or greater than the first distance 124.

For example, on a first side of the inner conductor 110 only the second insulative material 122 may be between the inner conductor 110 and the outer conductor 130. In these and other embodiments, the thickness of the second insulative material 122 may be equal to the second distance 126. In contrast, on a second side of the inner conductor 110, the second insulative material 122 and the first insulative material 120 may be between the inner conductor 110 and the outer conductor 130. In these and other embodiments, a combined thickness of the first insulative material 120 and the second insulative material 122 may be equal to the second distance 126.

As illustrated in FIG. 1b, the second insulative material 122 may be included in a portion of the bent portion 104 and the first insulative material 120 may be included in a remaining portion of the bent portion 104. In some embodiments, the second insulative material 122 may be included in the entire bent portion 104 and the first insulative material 120 may not be included in the bent portion 104. In these and other embodiments, the first insulative material 120 may be included in the entire non-bent portions 102.

In some embodiments, an amount of the second insulative material 122 included in the bent portion 104 may vary. In some embodiments, the amount may be increased or decreased. Alternately or additionally, a shape of the second insulative material 122 included in the bent portion 104 may vary. For example, the second insulative material 122 may be shaped as a rectangle, square, circle, quadrilateral, conical, diamond, elliptical, or any other shape.

In some embodiments, the second insulative material 122 may be located in cavities in the first insulative material 120. For example, the cavities in the first insulative material 120 may be formed using a drill, a press, a removable insert, or by some other mechanism. In some embodiments, the second insulative material 122 may be placed into the cavities in the first insulative material 120 and the outer conductor 130 may be formed over the first and second insulative materials 120 and 122. In some embodiments, the second insulative material 122 may be gases, such as air. In these and other embodiments, the gases may be allowed to enter the cavities while the outer conductor 130 may be formed over the first and second insulative materials 120 and 122.

Modifications, additions, or omissions may be made to the coaxial cable 100 without departing from the scope of the present disclosure. For example, in some embodiments, the cross-section of the coaxial cable 100 may be another shape. For example, the cross-section of the coaxial cable 100 may be round, square, quadrilateral, or elliptical, among other shapes.

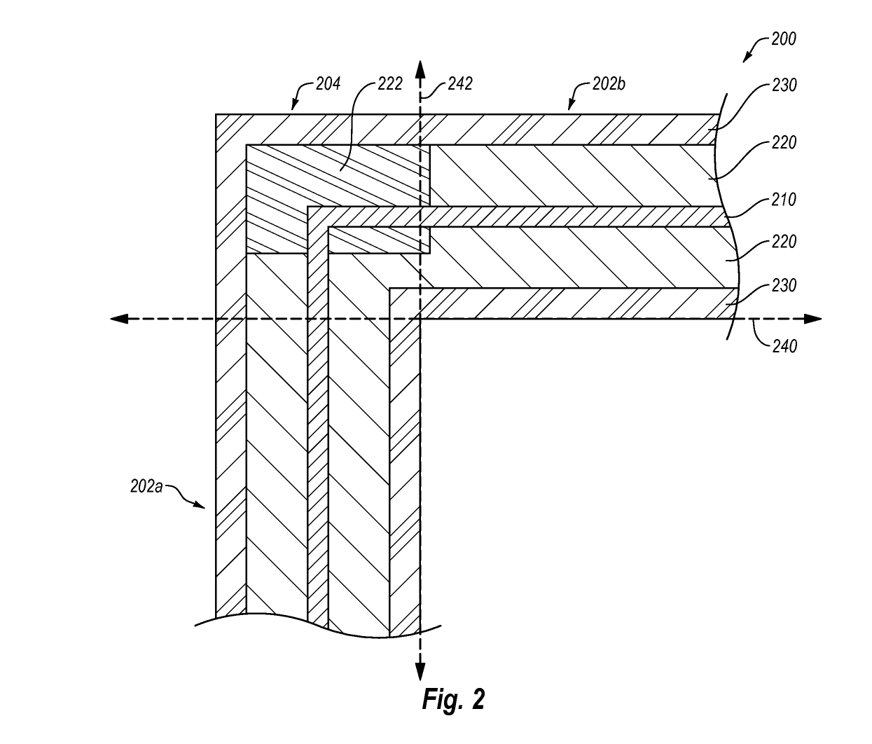

FIG. 2 illustrates a horizontal cross-section of another coaxial cable 200 with a bend, arranged in accordance with at least one embodiment of the present disclosure. The coaxial cable 200 may include an inner conductor 210, a first insulative material 220, a second insulative material 222, and an outer conductor 230. The first insulative material 220 and/or the second insulative material 222 may surround and contact the inner conductor 210 in a coaxial relationship. The outer conductor 230 may surround and contact the first insulative material 220 and/or second insulative material 222 in a coaxial relationship.

The coaxial cable 200 may also include first and second non-bent portions 202a and 202b (referred to herein as the non-bent portions 202) and a bent portion 204. The bent portion 204 of the coaxial cable 200 may result from a bend in the coaxial cable 200 that forms a 90 degree angle between the first and second non-bent portions 202a and 202b. In these and other embodiments, the bent portion 204 of the coaxial cable 200 may be distinguished from the non-bent portions 202 by first and second planes 240 and 242. The first and second planes 240 and 242 may be planes in which an outer surface of the outer conductor 230 resides.

As illustrated in FIG. 2, the bent portion 204 and the second non-bent portion 202b may include the first insulative material 220 and the second insulative material 222 between the inner conductor 210 and the outer conductor 230. The first and second insulative materials 220 and 222 may include one or more of a polyimide, carbon disulfide, polystyrene, polytetrafluoroethylene, polyethylene, or gases, among other types of dielectric or insulative materials.

In some embodiments, the second insulative material 222 may include a dielectric material that is different from the dielectric material of the first insulative material 220. In these and other embodiments, the first insulative material 220 may have a first dielectric constant and the second insulative material 222 may have a second dielectric constant. In some embodiments, the second dielectric constant may be lower than the first dielectric constant. For example, the first insulative material 220 may include a polyimide with a dielectric constant of 3.4 and the second insulative material 222 may include a polystyrene with a dielectric constant of 2.6.

In some embodiments, including the first and second insulative materials 220 and 222 in the bent portion 204 with different dielectric constants may reduce an impedance difference in the inner conductor 210 between the bent portion 204 and the non-bent portions 202.

In some embodiments, the second insulative material 222 may be added to the bent portion 204 and the second non-bent portion 202b while maintaining or enlarging a distance between the inner and outer conductors 210 and 230 in the bent portion 204 and the second non-bent portion 202b as compared to a distance between the inner and outer conductors 210 and 230 in the non-bent portions 202 with only the first insulative material 220.

In some embodiments, an amount of the second insulative material 222 included in the bent portion 204 and/or the second non-bent portion 202b may vary. In some embodiments, the amount may be increased or decreased. Alternately or additionally, a shape of the second insulative material 222 included in the bent portion 204 and/or the second non-bent portion 202b may vary. For example, the second insulative material 222 may be shaped as a rectangle, square, circle, quadrilateral, conical, diamond, elliptical, or any other shape.

Modifications, additions, or omissions may be made to the coaxial cable 200 without departing from the scope of the present disclosure. For example, the second insulative material 222 may be included in the bent portion 204 and the first non-bent portion 202a. Alternately or additionally, the second insulative material 222 may be included in the bent portion 204, the first non-bent portion 202a, and the second non-bent portion 202b. As another example, the coaxial cable 200 may have a bend that is less than or more than 90 degrees.

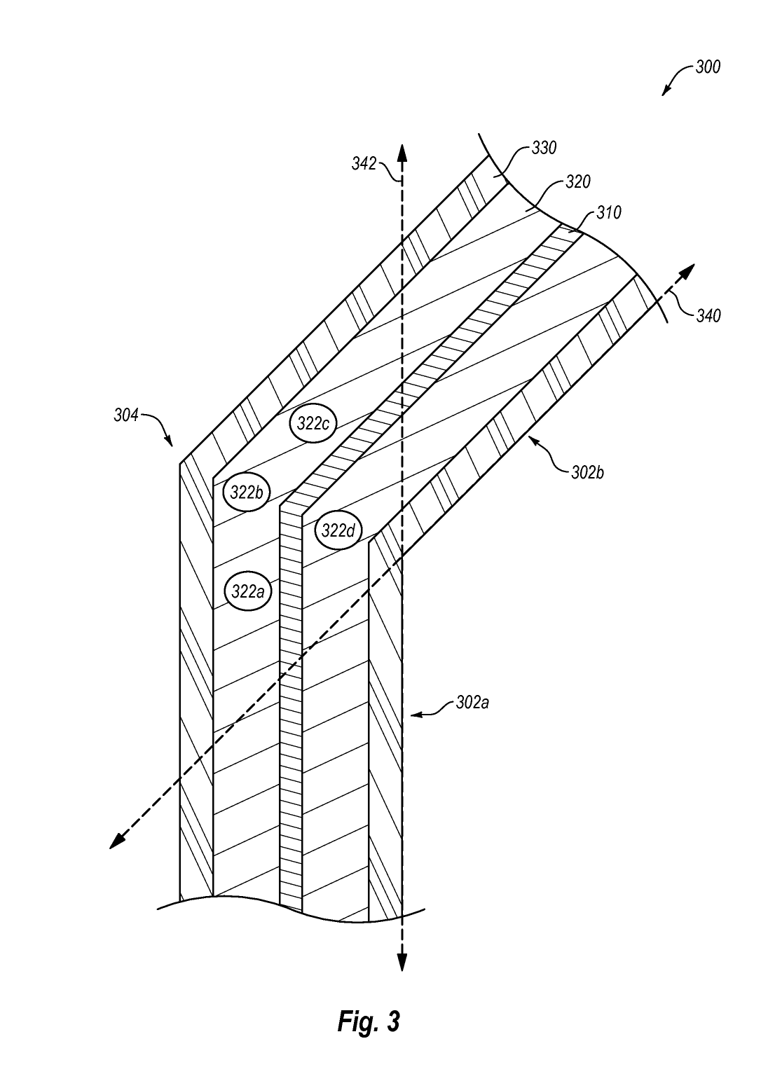

FIG. 3 illustrates a horizontal cross-section of another coaxial cable 300 with a bend, arranged in accordance with at least one embodiment of the present disclosure. The coaxial cable 300 may include an inner conductor 310, a first insulative material 320, a first mass of second insulative material 322a, a second mass of second insulative material 322b, a third mass of second insulative material 322c, a fourth mass of second insulative material 322d, and an outer conductor 330. The first mass of second insulative material 322a, the second mass of second insulative material 322b, the third mass of second insulative material 322c, and the fourth mass of second insulative material 322d may be referred to herein collectively as the second insulative material 322. The first insulative material 320 and the second insulative material 322 may surround and contact the inner conductor 310 in a coaxial relationship. The outer conductor 330 may surround and contact the first insulative material 320 and/or second insulative material 322 in a coaxial relationship.

The coaxial cable 300 may also include first and second non-bent portions 302a and 302b (referred to herein as the non-bent portions 302) and a bent portion 304. The bent portion 304 of the coaxial cable 300 may result from a bend in the coaxial cable 300 that forms a 135 degree angle between the first and second non-bent portions 302a and 302b. In these and other embodiments, the bent portion 304 of the coaxial cable 300 may be distinguished from the non-bent portions 302 by first and second planes 340 and 342. The first and second planes 340 and 342 may be planes in which an outer surface of the outer conductor 330 resides.

As illustrated in FIG. 3, the bent portion 304 may include the first insulative material 320 and the second insulative material 322 between the inner conductor 310 and the outer conductor 330. The non-bent portions 302 may include the first insulative material 320 and not include the second insulative material 322. The first and second insulative materials 320 and 322 may include one or more of a polyimide, carbon disulfide, polystyrene, polytetrafluoroethylene, polyethylene, or gases, among other types of dielectric or insulative materials.

As illustrated in FIG. 3, the second insulative material 322 is distributed in the first insulative material 320 in the bent portion 304 as the first mass of second insulative material 322a, the second mass of second insulative material 322b, the third mass of second insulative material 322c, and the fourth mass of second insulative material 322d. In some embodiments, the masses of the second insulative material 322 may be equally distributed throughout the first insulative material 320 at the bent portion 304. In some embodiments, the masses of the second insulative material 322 may be unequally distributed throughout the first insulative material 320 at the bent portion 304. In some embodiments, more of the masses of the second insulative material 322 may be between an outside corner of the inner conductor 310 and the outer conductor 330 than are between an inside corner of the inner conductor 310 and the outer conductor 330 as illustrated in FIG. 3.

In some embodiments, a number of the masses of the second insulative material 322 included in the bent portion 304 may vary. The four masses illustrated in FIG. 3 are provided by way of example. In some embodiments, the number of the masses of the second insulative material 322 included in the bent portion 304 may be increased or decreased.

In some embodiments, a shape of the first mass of second insulative material 322a, the second mass of second insulative material 322b, the third mass of second insulative material 322c, and the fourth mass of second insulative material 322d may each be the same, different, or some combination of the same and different shapes. In some embodiments, a size of the first mass of second insulative material 322a, the second mass of second insulative material 322b, the third mass of second insulative material 322c, and the fourth mass of second insulative material 322d may each be the same, different, or some combination of the same and different sizes.

In some embodiments, the second insulative material 322 may include a dielectric material that is different from the dielectric material of the first insulative material 320. In these and other embodiments, the first insulative material 320 may have a first dielectric constant and the second insulative material 322 may have a second dielectric constant. In some embodiments, the second dielectric constant may be lower than the first dielectric constant. For example, the first insulative material 320 may include a polyimide with a dielectric constant of 3.4 and the second insulative material 322 may include a polystyrene with a dielectric constant of 2.6.

In some embodiments, including the first and second insulative materials 320 and 322 in the bent portion 304 with different dielectric constants may reduce an impedance difference in the inner conductor 310 between the bent portion 304 and the non-bent portions 302.

In some embodiments, the second insulative material 322 may be added to the bent portion 304 and the second non-bent portion 302b while maintaining or enlarging a distance between the inner and outer conductors 310 and 330 in the bent portion 304 and the second non-bent portion 302b as compared to a distance between the inner and outer conductors 310 and 330 in the non-bent portions 302 with only the first insulative material 320.

In some embodiments, the first mass of second insulative material 322a, the second mass of second insulative material 322b, the third mass of second insulative material 322c, and the fourth mass of second insulative material 322d may be formed by drilling or otherwise creating cavities in the first insulative material 320 and providing the cavities with the second insulative material 322.

Modifications, additions, or omissions may be made to the coaxial cable 300 without departing from the scope of the present disclosure. For example, in some embodiments, one or more of the first mass of second insulative material 322a, the second mass of second insulative material 322b, the third mass of second insulative material 322c, and the fourth mass of second insulative material 322d may be included in the non-bent portions 302 of the coaxial cable. As another example, the coaxial cable 300 may have a bend that is less than or more than 135 degrees.

As another example, the first mass of second insulative material 322a, the second mass of second insulative material 322b, the third mass of second insulative material 322c, and the fourth mass of second insulative material 322d may each include a different insulative material with a different dielectric constant. Alternately or additionally, some of the first mass of second insulative material 322a, the second mass of second insulative material 322b, the third mass of second insulative material 322c, and the fourth mass of second insulative material 322d may include the same and different insulative materials with different dielectric constants. For example, the dielectric constant of the first mass of second insulative material 322a and the second mass of second insulative material 322b may be different from the dielectric constant of the third mass of second insulative material 322c and the fourth mass of second insulative material 322d, as well as the dielectric constant of the first insulative material 320.

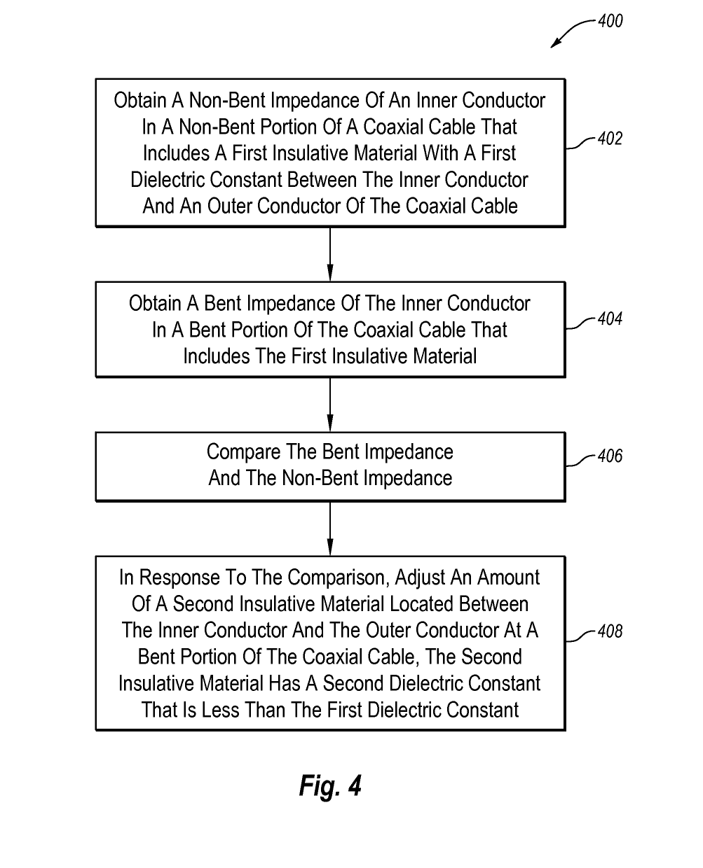

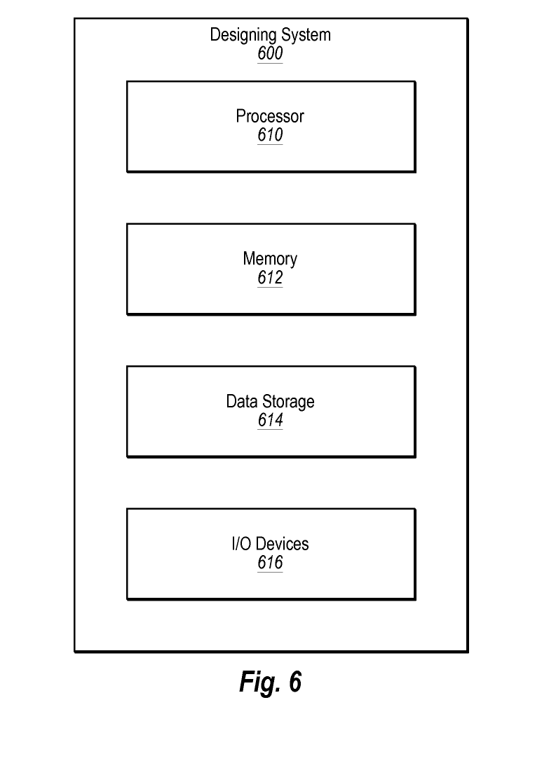

FIG. 4 is a flow chart of an example method 400 to design a coaxial cable with a bend, which may be arranged in accordance with at least one embodiment described herein. The method 400 may be implemented, in some embodiments, by a system, such as the system 600 of FIG. 6. Although illustrated as discrete blocks, various blocks may be divided into additional blocks, combined into fewer blocks, or eliminated, depending on the desired implementation.

The method 400 may begin at block 402, where a non-bent impedance of an inner conductor in a non-bent portion of a coaxial cable may be obtained. The coaxial cable may include a first insulative material with a first dielectric constant between the inner conductor and an outer conductor of the coaxial cable.

In block 404, a bent impedance of the inner conductor in a bent portion of the coaxial cable that includes the first insulative material may be obtained. In block 406, the bent impedance and the non-bent impedance may be compared.

In block 408, in response to the comparison, an amount of a second insulative material located between the inner conductor and the outer conductor at a bent portion of the coaxial cable may be adjusted. In some embodiments, the second insulative material has a second dielectric constant that is less than the first dielectric constant. In some embodiments, the second insulative material may include gases, such as air.

In some embodiments, in response to the bent impedance being greater than the non-bent impedance, the adjusting the amount of the second insulative material may include decreasing the amount of the second insulative material. In some embodiments, in response to the bent impedance being less than the non-bent impedance, the adjusting the amount of the second insulative material may include increasing the amount of the second insulative material. In some embodiments, increasing or decreasing the amount of the second insulative material may include increasing or decreasing a number of masses of the second insulative material that are distributed throughout the first insulative material at the bent portion of the coaxial cable.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 400 may further include in response to the comparison, adjusting the second dielectric constant of the second insulative material. In these and other embodiments, in response to the bent impedance being greater than the non-bent impedance, the adjusting the amount of the second insulative material may include decreasing the amount of the second insulative material and increasing the second dielectric constant of the second insulative material. In these and other embodiments, in response to the bent impedance being less than the non-bent impedance, the adjusting the amount of the second insulative material may include increasing the amount of the second insulative material and decreasing the second dielectric constant of the second insulative material.

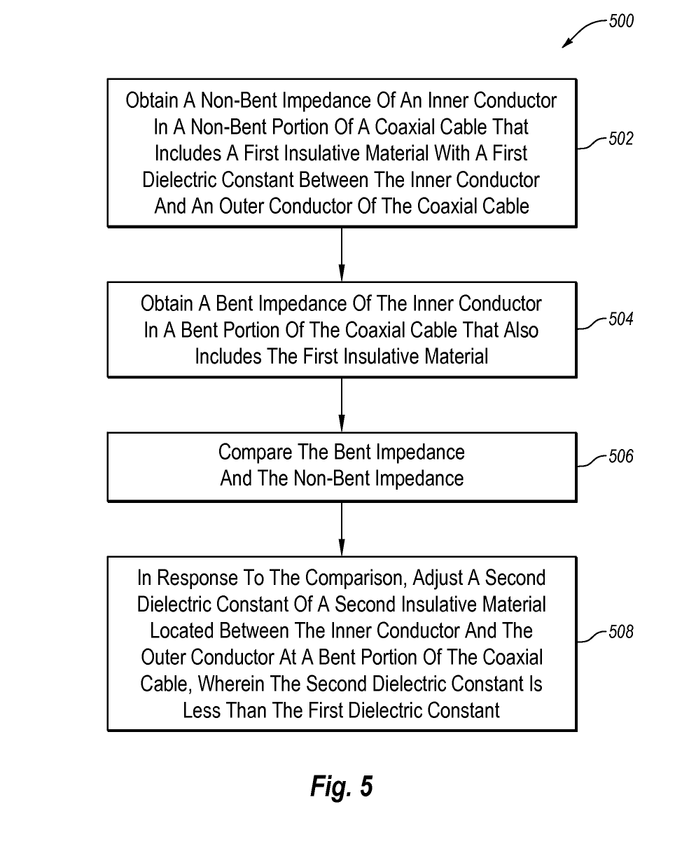

FIG. 5 is a flow chart of an example method 500 to design a coaxial cable with a bend, which may be arranged in accordance with at least one embodiment described herein. The method 500 may be implemented, in some embodiments, by a system, such as the system 600 of FIG. 6. Although illustrated as discrete blocks, various blocks may be divided into additional blocks, combined into fewer blocks, or eliminated, depending on the desired implementation.

The method 500 may begin at block 502, where a non-bent impedance of an inner conductor in a non-bent portion of a coaxial cable may be obtained. The coaxial cable may include a first insulative material with a first dielectric constant between the inner conductor and an outer conductor of the coaxial cable.

In block 504, a bent impedance of the inner conductor in a bent portion of the coaxial cable that also includes the first insulative material may be obtained. In block 506, the bent impedance and the non-bent impedance may be compared.

In block 508, in response to the comparison, a second dielectric constant of a second insulative material located between the inner conductor and the outer conductor at a bent portion of the coaxial cable may be adjusted. In these and other embodiments, the second dielectric constant may be less than the first dielectric constant. In some embodiments, the second insulative material may include gases.

In some embodiments, adjusting the second dielectric constant of the second insulative material may include increasing or decreasing the second dielectric constant. For example, in some embodiments, in response to the bent impedance being greater than the non-bent impedance, the adjusting the second dielectric constant of the second insulative material may include increasing the second dielectric constant. In these and other embodiments, in response to the bent impedance being less than the non-bent impedance, the adjusting the second dielectric constant of the second insulative material may include decreasing the second dielectric constant.

FIG. 6 illustrates a system 600 configured to design a coaxial cable with a bend, arranged in accordance with at least one embodiment of the present disclosure. Generally, the system 600 may include any hardware or software that may be used to design a coaxial cable with a bend. In some embodiments, the system 600 may perform the method as illustrated in FIG. 6.

As illustrated in FIG. 6, the system 600 may include a processor 610, a memory 612, data storage 614, and an I/O device 616. In these and other embodiments, the processor 610, the memory 612, the data storage 614, and the I/O device 616 may be configured to perform some or all of the operations performed by the system 600. In other embodiments, the system 600 may not include one or more of the processor 610, the memory 612, the data storage 614, and I/O device 616.

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 6, it is understood that the processor 610 may include any number of processors distributed across any number of network or physical locations that are configured to perform individually or collectively any number of operations described herein. In some embodiments, the processor 610 may interpret and/or execute program instructions and/or process data stored in the memory 612, the data storage 614, or the memory 612 and the data storage 614. In some embodiments, the processor 610 may fetch program instructions from the data storage 614 and load the program instructions in the memory 612. After the program instructions are loaded into the memory 612, the processor 610 may execute the program instructions.

The memory 612 and data storage 614 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 610. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 610 to perform a certain operation or group of operations.

In some embodiments, the system 600 may perform operations, such as directed by program instructions, to design a coaxial cable with a bend. In these and other embodiments, the system 600 may perform the operations in a simulation environment, such as a Simulation Program with Integrated Circuit Emphasis (SPICE) or some ether type of electrical circuit simulation environment. The system 600 may design the coaxial cable to have first and second insulative materials in the bent portion with different dielectric constants.

In these and other embodiments, the system 600 may perform operations to perform a simulation on parameters entered for a coaxial cable with a bend. The system 600 may perform operations to obtain a non-bent impedance of an inner conductor in a non-bent portion of a coaxial cable and a bent impedance of the inner conductor in a bent portion of the coaxial cable. The system 600 may perform operations to compare the bent impedance and the non-bent impedance. In response to the comparison, the system 600 may adjust an amount of second insulative material at the bend located between an inner conductor and an outer conductor of the coaxial cable.

After adjusting the amount of second insulative material, the system 600 may perform operations to obtain the bent impedance of the inner conductor in the bent portion with the increased thickness. The system 600 may continue to adjust the amount of the second insulative material at the bend until an impedance difference between the non-bent impedance and the bent impedance reaches a particular threshold.

In some embodiments, in response to the bent impedance being greater than the non-bent impedance, the system 600 may decrease the amount of the second insulative material at the bend. Alternately or additionally, in response to the bent impedance being less than the non-bent impedance, the system 600 may increase the amount of the second insulative material at the bend. In these and other embodiments, increasing and/or decreasing the amount of the second insulative material at the bend may not increase a distance between inner and outer conductors of the coaxial cable at the bend. Rather, increasing and/or decreasing the amount of the second insulative material at the bend may include increasing or decreasing the amount of the second insulative material in relation to the first insulative material.

In some embodiments, in response to the bent impedance being greater or less than the non-bent impedance, the system 600 may adjust a shape, distribution, or location or one or more masses of the second insulative material at the bend. In some embodiments, the system 600 may determine the decrease, increase, and/or change in the masses of the second insulative material independently, based on user input, or using input only from the user. In these and other embodiments, the user may provide input through the I/O devices 616.

In some embodiments, the system 600 may also adjust a dielectric constant of the second insulative material at the bend to adjust the bend impedance of the inner conductor. In these and other embodiments, in response to the bent impedance being greater than the non-bent impedance, the system 600 may increase the dielectric constant of the second insulative material at the bend. Alternately or additionally, in response to the bent impedance being less than the non-bent impedance, the system 600 may decrease the dielectric constant of the second insulative material at the bend. In some embodiments, increasing or decreasing the dielectric constant may include changing or adjusting the second insulative material. For example, two insulative materials may be combined to form a second insulative material with an adjusted dielectric constant.

In some embodiments, the system 600 may adjust only an amount, shape, distribution, or location of the second insulative material at the bend. Alternately or additionally, the system 600 may adjust only the dielectric constant of the second insulative material at the bend. Alternately or additionally, the system 600 may adjust some combination of the amount, shape, distribution, or location of the second insulative material at the bend and the dielectric constant of the second insulative material at the bend. Modifications, additions, or omissions may be made to the system 600 without departing from the scope of the present disclosure.

While some of the systems and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A coaxial cable, comprising:
an inner conductor;
an outer conductor surrounding the inner conductor in a coaxial relationship;
a first insulative material located between the inner conductor and the outer conductor at a non-bent portion of the coaxial cable and a bent portion of the coaxial cable, the first insulative material has a first dielectric constant; and
a second insulative material located between the inner conductor and the outer conductor at the bent portion of the coaxial cable, the second insulative material has a second dielectric constant that is lower than the first dielectric constant.

2. The coaxial cable of claim 1, wherein at the bent portion of the coaxial cable, the inner conductor forms a non-sweeping approximately 90 degree angle.

3. The coaxial cable of claim 1, wherein the second insulative material fills a cavity in the first insulative material at the bent portion of the coaxial cable.

4. The coaxial cable of claim 1, wherein the second insulative material includes a plurality of masses of the second insulative material that are distributed throughout the first insulative material at the bent portion of the coaxial cable.

5. The coaxial cable of claim 4, wherein the plurality of masses of the second insulative material have a varying size, a varying shape, or both a varying size and shape.

6. The coaxial cable of claim 4, wherein the plurality of masses of the second insulative material are equally distributed throughout the first insulative material at the bent portion of the coaxial cable.

7. The coaxial cable of claim 1, wherein the non-bent portion of the coaxial cable further includes the second insulative material.

8. A coaxial cable, comprising:
an inner conductor;
an outer conductor surrounding the inner conductor in a coaxial relationship, a distance between the inner conductor and the outer conductor is substantially the same or greater at a bent portion of the coaxial cable than at a non-bent portion of the coaxial cable;
a first insulative material located between the inner conductor and the outer conductor at the non-bent portion of the coaxial cable, the first insulative material has a first dielectric constant; and
a second insulative material located between the inner conductor and the outer conductor at the bent portion of the coaxial cable, the second insulative material has a second dielectric constant that is lower than the first dielectric constant.

9. The coaxial cable of claim 8, wherein at the bent portion of the coaxial cable, the inner conductor forms a non-sweeping approximately 90 degree angle.

10. The coaxial cable of claim 8, wherein the bent portion of the coaxial cable further includes the first insulative material.

11. The coaxial cable of claim 10, wherein the second insulative material fills a cavity in the first insulative material at the bent portion of the coaxial cable.

12. The coaxial cable of claim 10, wherein the second insulative material includes a plurality of masses of the second insulative material that are distributed throughout the first insulative material at the bent portion of the coaxial cable.

13. The coaxial cable of claim 12, wherein the plurality of masses of the second insulative material are equally distributed throughout the first insulative material at the bent portion of the coaxial cable.

14. A method, comprising:
obtaining a non-bent impedance of an inner conductor in a non-bent portion of a coaxial cable that includes a first insulative material with a first dielectric constant between the inner conductor and an outer conductor of the coaxial cable;
obtaining a bent impedance of the inner conductor in a bent portion of the coaxial cable that includes the first insulative material;
comparing the bent impedance and the non-bent impedance; and
in response to the comparison, adjusting an amount of a second insulative material located between the inner conductor and the outer conductor at a bent portion of the coaxial cable, the second insulative material has a second dielectric constant that is lower than the first dielectric constant.

15. The method of claim 14, wherein in response to the bent impedance being greater than the non-bent impedance, the adjusting the amount of the second insulative material includes decreasing the amount of the second insulative material.

16. The method of claim 14, wherein in response to the bent impedance being less than the non-bent impedance, the adjusting the amount of the second insulative material includes increasing the amount of the second insulative material.

17. The method of claim 14, wherein the adjusting the amount of the second insulative material includes increasing or decreasing a number of masses of the second insulative material that are distributed throughout the first insulative material at the bent portion of the coaxial cable.

18. The method of claim 14, further comprising in response to the comparison, adjusting the second dielectric constant of the second insulative material.

19. The method of claim 18, wherein in response to the bent impedance being greater than the non-bent impedance, the adjusting the amount of the second insulative material includes decreasing the amount of the second insulative material and increasing the second dielectric constant of the second insulative material.

20. The method of claim 18, wherein in response to the bent impedance being less than the non-bent impedance, the adjusting the amount of the second insulative material includes increasing the amount of the second insulative material and decreasing the second dielectric constant of the second insulative material.
